(19) United States
(12) Patent Application Publication
(10) Pub. No.: US 2025/0150208 A1
(43) Pub. Date: May 8, 2025

(54) METHOD, DEVICE AND COMPUTER STORAGE MEDIUM OF COMMUNICATION

(71) Applicant: NEC CORPORATION, Tokyo (JP)

(72) Inventors: Xiaohong ZHANG, Beijing (CN); Gang WANG, Beijing (CN)

(73) Assignee: NEC CORPORATION, Tokyo (JP)

(21) Appl. No.: 18/684,386

(22) PCT Filed: Aug. 17, 2021
(86) PCT No.: PCT/CN2021/113120

§ 371 Date: Feb. 16, 2024

(51) Int. Cl. H04L 1/1812

(52) U.S. Cl. CPC H04L 1/1812

(57) ABSTRACT

Embodiments of the present disclosure relate to methods, devices and computer readable media for communication. A first device receives, from a second device, at least one data transmission on at least one occasion in a first number of occasions, the first number of occasions being configured within a period. The first device transmits, to the second device, a second number of information blocks for a HARQ feedback for the at least one data transmission, the second number being less than the first number. In this way, an effect of jitter is alleviated, complexity of a terminal device for blind detection is reduced, and signaling overhead on HARQ feedback is saved.

### TECHNICAL FIELD

Embodiments of the present disclosure generally relate to the field of telecommunication, and in particular, to methods, devices and computer storage media of communication for a hybrid automatic repeat request (HARQ) feedback transmission.

### BACKGROUND

SPS downlink (DL) transmission and Type 1 or 2 configured grant (CG) uplink (UL) transmission are supported and enhanced in new radio (NR) technology. They are beneficial to services with periodic packets in terms of control signaling overhead and scheduling latency, especially for an extended reality (XR) service such as virtual reality (VR), augmented reality (AR), cloud gaming, etc.

Typically, packets will arrive at radio access network (RAN) every 1/frames per second (FPS). The arriving tends to occur in a range of jitter due to various factors. An effect of jitter is identified as an important aspect for services such as the XR service. It has been proposed that over-provided SPS occasions (i.e., configuring more and denser SPS occasions than the transmission needs) are used to alleviate the effect of the jitter. However, over-provisioning of transmission occasions will cause many issues such as increased complexity of a terminal device for blind detection and increased signaling overhead on HARQ feedback for the multiple transmission occasions.

### SUMMARY

In general, embodiments of the present disclosure provide methods, devices and computer storage media of communication for HARQ feedback transmission.

In a first aspect, there is provided a method of communication. The method comprises: receiving, at a first device, at least one data transmission from a second device on at least one occasion in a first number of occasions, the first number of occasions being configured within a period; transmitting, to the second device, a second number of information blocks for a HARQ feedback for the at least one data transmission, the second number being less than the first number.

In a second aspect, there is provided a method of communication. The method comprises: receiving, at a first device, a configuration for semi-persistent scheduling from a second device, the configuration indicating a period and a first number of occasions within the period; and determining an identity of a HARQ process for an occasion in the first number of occasions at least based on a second number and an offset value for the occasion.

In a third aspect, there is provided a method of communication. The method comprises: transmitting, at a second device and to a first device, at least one data transmission on at least one occasion in a first number of occasions, the first number of occasions being configured within a period; and receiving, from the first device, a second number of information blocks for a HARQ feedback for the at least one data transmission, the second number being less than the first number.

In a fourth aspect, there is provided a method of communication. The method comprises: transmitting, at a second device, a configuration for semi-persistent scheduling to a first device, the configuration indicating a period and a first number of occasions within the period; and determining an identity of a HARQ process for an occasion in the first number of occasions at least based on a second number and an offset value for the occasion.

In a fifth aspect, there is provided a device of communication. The device comprises a processor configured to perform the method according to the first or second aspect of the present disclosure.

In a sixth aspect, there is provided a device of communication. The device comprises a processor configured to perform the method according to the third or fourth aspect of the present disclosure.

In a seventh aspect, there is provided a computer readable medium having instructions stored thereon. The instructions, when executed on at least one processor, cause the at least one processor to perform the method according to the first or second aspect of the present disclosure.

In an eighth aspect, there is provided a computer readable medium having instructions stored thereon. The instructions, when executed on at least one processor, cause the at least one processor to perform the method according to the third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating an example scenario of SPS transmission for alleviation of jitter according to conventional solution;

FIG. 3 illustrates a schematic diagram illustrating a process for communication according to embodiments of the present disclosure;

FIG. 4 illustrates a schematic diagram illustrating an example SPS configuration according to embodiments of the present disclosure;

FIG. 5A illustrates a schematic diagram illustrating an example SPS transmission according to embodiments of the present disclosure;

FIG. 5B illustrates a schematic diagram illustrating an example HARQ feedback for SPS transmission according to embodiments of the present disclosure;

FIG. 5C illustrates a schematic diagram illustrating another example HARQ feedback for SPS transmission according to embodiments of the present disclosure;

FIG. 6A illustrates a schematic diagram illustrating another example SPS transmission according to embodiments of the present disclosure;

FIG. 6B illustrates a schematic diagram illustrating another example HARQ feedback for SPS transmission according to embodiments of the present disclosure;

FIG. 7A illustrates a schematic diagram illustrating an example grouping of SPS configured occasions according to embodiments of the present disclosure;

FIG. 7B illustrates a schematic diagram illustrating another example grouping of SPS configured occasions according to embodiments of the present disclosure;

FIG. 8 illustrates a schematic diagram illustrating an example indication of SPS configured occasions according to embodiments of the present disclosure;

FIG. 9A illustrates a schematic diagram illustrating another example indication of SPS configured occasions according to embodiments of the present disclosure;

FIG. 9B illustrates a schematic diagram illustrating another example indication of SPS configured occasions according to embodiments of the present disclosure;

FIG. 9C illustrates a schematic diagram illustrating another example indication of SPS configured occasions according to embodiments of the present disclosure;

FIG. 10 illustrates a schematic diagram illustrating another process for communication according to embodiments of the present disclosure;

FIG. 11 illustrates an example method of communication implemented at a first device in accordance with some embodiments of the present disclosure;

FIG. 12 illustrates another example method of communication implemented at a first device in accordance with some embodiments of the present disclosure;

FIG. 13 illustrates an example method of communication implemented at a second device in accordance with some embodiments of the present disclosure;

FIG. 14 illustrates another example method of communication implemented at a second device in accordance with some embodiments of the present disclosure; and

FIG. 15 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “occasion” refers to any of the following: 1) a time domain resource assigned or granted for a data transmission, for example, the time domain resource may include one or more slots, one or more mini-slots, or one or more symbols; 2) one or more slots in which a DL assignment, UL grant or sidelink grant occurs; 3) one or more symbols in which a DL assignment, UL grant or sidelink grant occurs.

In the context of the present application, the term “symbol” refers to an orthogonal frequency division multiplexing (OFDM) symbol or a discrete Fourier transform spread OFDM (DFT-s-OFDM) symbol. The term “slot” includes multiple consecutive symbols, e.g., 14 symbols, or 12 symbols. The term “mini-slot” includes one or more consecutive symbols, and has less symbol than a slot, e.g., 1, 2, 4, or 7 symbols.

In the context of the present application, the term “data transmission” may refer to a physical downlink shared channel (PDSCH), a physical uplink shared channel (PUSCH) or a physical sidelink shared channel (PSSCH).

As mentioned above, the over-provisioning of transmission occasions (for convenience, also referred to as occasions hereinafter) will cause many issues such as increased complexity of a terminal device for blind detection and increased signaling overhead on a HARQ feedback for the occasions. These issues also exist in the case that multiple occasions are configured within a period.

In view of this, embodiments of the present disclosure provide solutions for solving the above and other potential issues for the case that multiple occasions are configured within a period. In one aspect, a solution for transmission of a HARQ feedback is provided where the HARQ feedback is generated and transmitted only for a portion of the multiple occasions. In this way, an effect of jitter may be alleviated, complexity of a terminal device for blind detection may be reduced, and signaling overhead on HARQ feedback may be saved.

In another aspect, a solution for determination of a HARQ process identity (ID) is provided where the HARQ process ID is generated for each occasion. In this way, collision and waste in the HARQ process ID may be avoided.

Principles and implementations of the present disclosure will be described in detail below with reference to the figures.

### Example of Communication Network

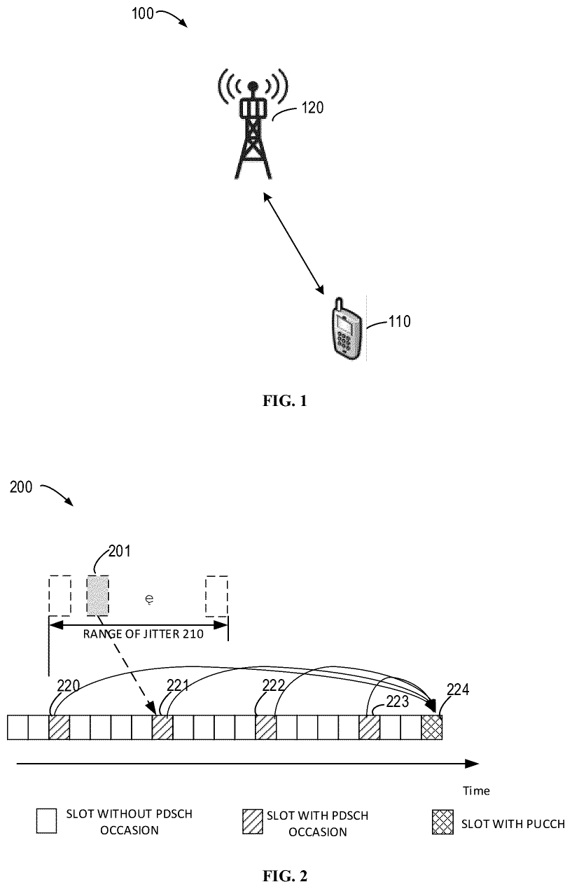

FIG. 1 illustrates a schematic diagram of an example communication network 100 in which some embodiments of the present disclosure can be implemented. As shown in FIG. 1, the communication network 100 may include a first device 110 and a second device 120. In some embodiments, the first device 110 may be served by the second device 120. The first device 110 and the second device 120 may communicate with each other via a channel such as a wireless communication channel. In some embodiments, the first device 110 may directly communicate with the second device 120. In some embodiments, the first device 110 may communicate with the second device via another device (not shown).

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

It is to be understood that the number of devices in FIG. 1 is given for the purpose of illustration without suggesting any limitations to the present disclosure. The communication network 100 may include any suitable number of first devices and/or second devices adapted for implementing implementations of the present disclosure.

For illustration, the first device 110 is shown as a terminal device and the second device 120 is shown as a network device. Merely for illustration purpose and without suggesting any limitations as to the scope of the present disclosure, some embodiments will be described in the context where the first device 110 is a terminal device and the second device 120 is a network device. It is to be understood that, in other embodiments, the first device 110 may be a network device and the second device 120 may be a terminal device. In other words, the principles and spirits of the present disclosure can be applied to both uplink and downlink transmissions. Further, in some embodiments, both the first device 110 and the second device 120 may be terminal devices, and in some embodiments, both the first device 110 and the second device 120 may be network devices.

In some embodiments, the second device 120 may transmit a configuration regarding a periodicity of occasions for SPS DL transmissions. In this case, the first device 110 may receive, from the second device 120, data packets on at least part of the occasions. In some embodiments, the second device 120 may transmit a configuration regarding a periodicity of occasions for CG UL transmissions. In this case, the first device 110 may transmit, to the second device 120, data packets on at least part of the occasions. In some embodiments, the second device 120 may transmit a configuration regarding a periodicity of occasions for CG sidelink transmissions. In this case, the first device 110 may receive, from the second device 120, data packets on at least part of the occasions. In some embodiments, the second device 120 may transmit, to the first device 110, a configuration regarding a periodicity of occasions for CG sidelink transmissions. In this case, the first device 110 may receive from or transmit to a device other than the second device 120 data packets on at least part of the occasions.

In some embodiments, the second device 120 may transmit, to the first device 110, a configuration regarding an occasion within a period. In some embodiments, the second device 120 may transmit, to the first device 110, a configuration regarding multiple occasions within a period.

In some scenarios, a first device may want to transmit XR frame packets to a second device or receive XR frame packets from the second device. For an XR video stream with 60 FPS, XR frame packets will averagely arrive at RAN every 1/60 second. However, there is a significant jitter effect for arrival time of each XR frame packet. As modeled from a truncated Gaussian distribution, a range of jitter may be in 8 ms or 10 ms. On the other hand, a requirement of packet delay budget (PDB) for each XR frame packet is quite stringent, e.g., 10/15 ms. Thus, it is required that each XR frame packet is transmitted as soon as possible after it arrives at RAN.

In a conventional solution, a shorter SPS periodicity and simultaneous activation of multiple SPS/CG configurations are supported to alleviate the jitter issue. That is, jitter is alleviated by the over-provision SPS configuration. FIG. 2 illustrates a schematic diagram 200 illustrating an example scenario of SPS transmission for alleviation of jitter according to conventional solution. Assuming that an XR video stream with 60 FPS is to be transmitted.

As shown in FIG. 2, XR frame packet 201 in the XR video stream may arrive at RAN in a point of time within a range of jitter 210. In this example, a periodicity of a SPS configuration is 5 ms. Although the XR packet arrives every 16.67 ms on average, the SPS periodicity is configured much smaller than 16.67 ms to provide PDSCH occasions as early as possible after the arrival of the XR packet, due to a network device and a terminal device do not know the exact arrival time of the XR packet in advance. As shown in FIG. 2, PDSCH occasions 220, 221, 222 and 223 are periodically configured. That is, one occasion is configured within a period.

In the example of FIG. 2, only PDSCH occasion 221 is actually used by the network device for transmission of the XR frame packet 201, and the PDSCH occasions 220, 222 and 223 are unused. However, the terminal device generates a HARQ-acknowledgement (HARQ-ACK) codebook for all the four PDSCH occasions 220-223, even if the PDSCH occasions 220, 222 and 223 are not actually used. The terminal device transmits the HARQ-ACK codebook in a PUCCH slot 224. This causes an increased overhead for HARQ feedback and an increased complexity of blind detection.

The above description is made on the issue in a case where one occasion is configured within a period. The same issue also exists in the case of multiple occasions configured within a period. That is, the terminal device generates a HARQ-ACK codebook for all the multiple occasions, even if a portion of the multiple occasions are not actually used.

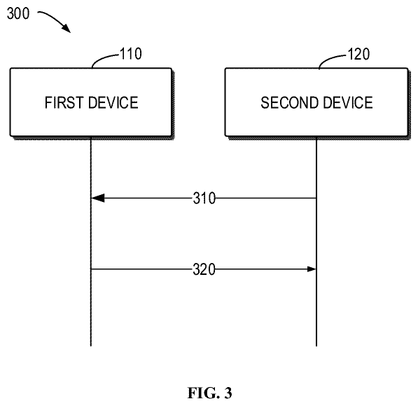

In view of the above, embodiments of the present disclosure provide a solution of HARQ feedback transmission for the case that multiple occasions are configured within a period. This will be described in detail with reference to FIGS. 3 to 9C.

### Example Implementation of HARQ Feedback

FIG. 3 illustrates a schematic diagram illustrating a process 300 for communication according to embodiments of the present disclosure. For the purpose of discussion, the process 300 will be described with reference to FIG. 1. The process 300 may involve the first device 110 and the second device 120 as illustrated in FIG. 1.

As shown in FIG. 3, the second device 120 transmits 310, to the first device 110, at least one data transmission on at least one occasion in a first number (for convenience, denoted as N herein) of occasions. The first number of occasions are configured within a period (for convenience, denoted as P herein) and the first number N is larger than one. In some embodiments, the first number of occasions may occur only once within a time duration P. In some embodiments, the first number of occasions may occur periodically with a periodicity P.

In some embodiments, the second device 120 may transmit, to the first device 110, a configuration regarding the period P and N resource assignments for N occasions within the period. The period P may refer to a number of time unit. The time unit may be one millisecond, one slot or one symbol. The number may be a positive integer number or a positive non-integer number. In some embodiments, the N resource assignments for N occasions may be indicated by a start and length indication value (SLIV) field in downlink control information (DCI).

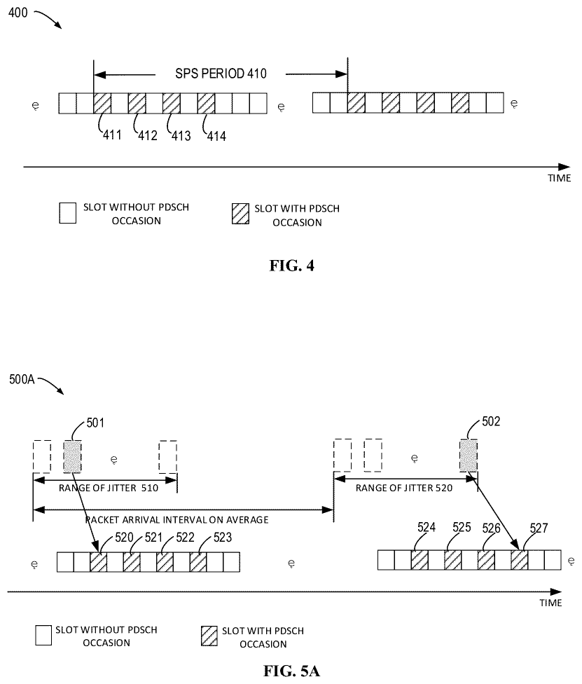

FIG. 4 illustrates a schematic diagram 400 illustrating an example SPS configuration according to embodiments of the present disclosure. As shown in FIG. 4, occasions 411, 412, 413 and 414 may be configured within a single SPS period 410. In some embodiments, the second device 120 may transmit a data transmission on one of the occasions 411-414. In some embodiments, the second device 120 may transmit multiple data transmissions on multiple occasions in the occasions 411-414.

Return to FIG. 3, the first device 110 transmits 320, to the second device 120, a second number (for convenience, denoted as M herein) of information blocks for a HARQ feedback for the at least one data transmission. In some embodiments, the second number may be less than the first number, i.e., M<N. In other words, upon receipt of the at least one data transmission, the first device 110 may generate the HARQ feedback for the second number of occasions in the first number of occasions.

In some embodiments, the first device 110 may receive, from the second device 120, a configuration indicating the second number M. The second number M means the maximum number of actually used occasions in the first number of occasions. The first device 110 does not expect to correctly receive more than M data transmissions within the period P and only feedbacks M information blocks.

In the context of the present disclosure, correctly receiving a data transmission in an occasion means correctly receiving at least one data block in the occasion. Further, successfully or correctly receiving or decoding or detecting a data block have the same meanings and can be used interchangeably with each other. Successfully or correctly receiving or decoding or detecting a data block may mean that the cyclic redundancy check (CRC) of the data block is successful or correct.

In some embodiments, the first device 110 may receive, from the second device 120, a configuration indicating a third number (for convenience, denoted as L herein). The third number refers to the number of data blocks in a single occasion. In some embodiments, all occasions in a period have the same value of L. In some embodiments, the data blocks may be transport blocks (TBs). In some embodiments, the data blocks may be code block groups (CBGs). In the context of the application, an information block comprises L HARQ-ACK information bits, and a HARQ-ACK information bit in the L HARQ-ACK information bits indicates whether the respective data block in an occasion is correctly or successfully received.

In this way, the second device 120 may start transmission of a XR frame packet as soon as possible after an arrival of the XR frame packet, and thus an effect of jitter may be alleviated. Further, the first device 110 may be allowed to blind detect less occasions and thus complexity of the first device 110 may be reduced. In addition, the first device 110 may be allowed to feedback less HARQ-ACK information, and thus signaling overhead may be saved.

For clarity, some embodiments will be described in details with reference to Embodiments 1-3.

### Embodiment 1

In this embodiment, the second number is one, i.e., M=1. In this case, the at least one data transmission comprise one data transmission, and the second number of information blocks comprise one information block. This embodiment is beneficial for the case that the data packet size is small or medium and the jitter is severe.

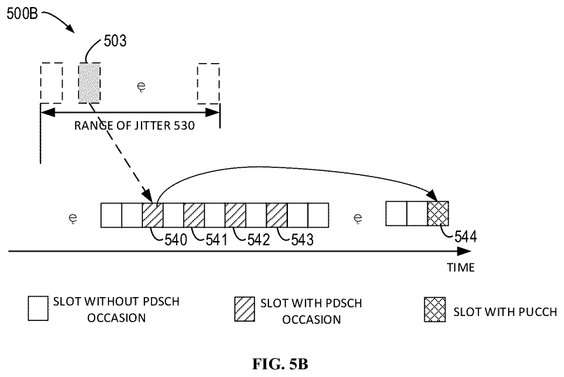

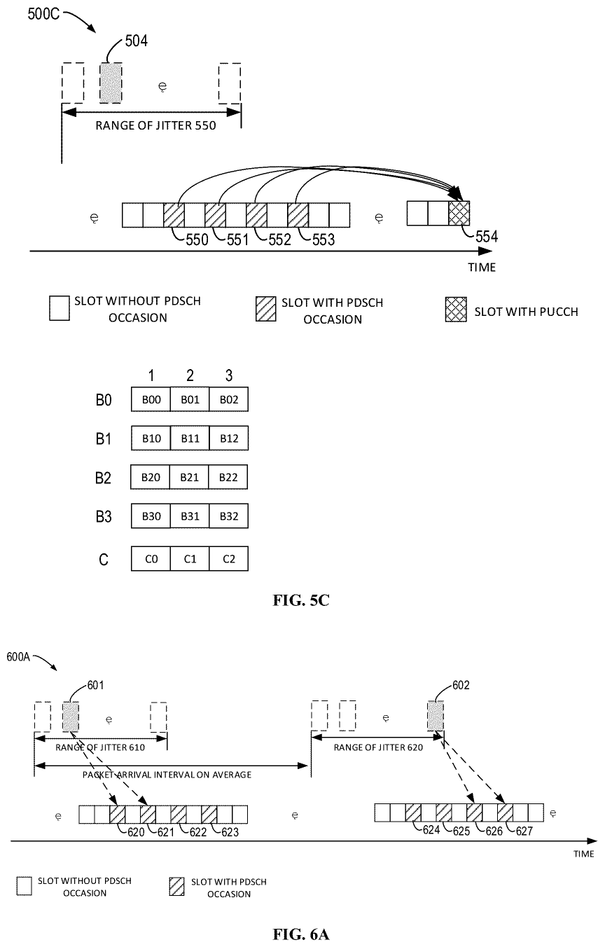

FIG. 5A illustrates a schematic diagram 500A illustrating an example SPS transmission according to embodiments of the present disclosure. As shown in FIG. 5A, packet 501 may arrive at RAN in a point of time within a range of jitter 510. Occasions 520-523 are configured within a first period, and occasions 524-527 are configured within a second period behind the first period. In this example, the second device 120 may transmit the packet 501 only on the occasion 520. After packet arrival interval on average, packet 502 may arrive at RAN in a point of time within a range of jitter 520. The second device 120 may transmit the packet 502 only on the occasion 527.

In some embodiments, if at least one data block for the one data transmission is received correctly or successfully on an occasion (also referred to as a first occasion herein) in the first number of occasions, the first device 110 does not expect to correctly receive a data block on any of remaining occasions (also referred to as a second occasion herein) in the first number of occasions. In other words, once the first device 110 correctly detects at least one data block in an occasion in the N occasions, the first device 110 may stop the detection of the remaining occasions in the N occasions. For example, as shown in FIG. 5A, once the first device 110 correctly detects at least one data block in the occasion 520, the first device 110 may stop the detection of the occasions 521, 522 and 523. As a result, the first device 110 may be allowed to blind detect less occasions and thus complexity of the first device 110 may be reduced. Meanwhile, as the second device 120 may start transmission of the packet as soon as possible upon an arrival of the packet, an effect of jitter may be alleviated.

FIG. 5B illustrates a schematic diagram 500B illustrating an example HARQ feedback for SPS transmission according to embodiments of the present disclosure. As shown in FIG. 5B, packet 503 may arrive at RAN in a point of time within a range of jitter 530. Occasions 540-543 are configured within a period. In this example, the second device 120 may transmit, to the first device 110, the packet 503 only on the occasion 540, and the first device 110 may transmit a HARQ feedback for only the occasion 540 in a slot 544.

In some embodiments, if no data block for the one data transmission is correctly received on the N occasions, the first device 110 may generate the one information block comprising L HARQ-ACK information bits and each of the L HARQ-ACK information bits indicates a negative acknowledgement (NACK).

In some embodiments, if a data block (also referred to as a first data block herein) in an occasion in the N occasions is correctly or successfully received, the first device 110 may generate a positive acknowledgement (ACK) for the data block. In some embodiments, if a data block (also referred to as a second data block herein) is received incorrectly on the occasion, the first device 110 may generate a HARQ-ACK information bit in the information block indicating a NACK for the data block. In other words, if the first device 110 is indicated more than one data blocks for a single occasion, and the first device 110 successfully detects at least one data block in an occasion, the first device 110 may generate NACK for one or more data blocks unsuccessfully detected in the same occasion if there are the one or more data blocks. In this way, an information block comprising M HARQ-ACK information bits may be obtained.

In some embodiments, the first device 110 may determine a position of the information block in the HARQ-ACK codebook based on the first occasion (for example, the occasion 540 in FIG. 5B) in the N occasions. In some embodiments, the first device 110 may determine a position of the information block in a HARQ-ACK codebook based on the last occasion (for example, the occasion 543 in FIG. 5) in the N occasions. Of course, the first device 110 may also determine the position of the information block in the HARQ-ACK codebook based on arbitrary occasion in the N occasions. In other words, the N occasions may share the same HARQ process ID. Then, the first device 110 may place the information block into the HARQ-ACK codebook based on the determined position, and transmit the HARQ-ACK codebook in the slot 544.

So far, the HARQ feedback for the one data transmission is transmitted from the first device 110 to the second device 120 with alleviated jitter effect, reduced complexity of blind detection, and saved signaling overhead.

### Embodiment 2

In this embodiment, the second number also is one. The first device 110 may perform blind detection for all the N occasions and generate the HARQ-ACK information for all the N occasions. Then, the first device 110 may generate L HARQ-ACK information bits by performing “OR” operation on respective bits in the HARQ-ACK information.

In some embodiments, the first device 110 may generate N information blocks for the N occasions. Each of the N information blocks includes L HARQ-ACK information bits for data blocks in the respective occasion. That is, the L HARQ-ACK information bits indicate whether the data blocks are received correctly on the respective occasion.

In some embodiments, the first device 110 may generate an information block by performing OR operation on HARQ-ACK information bits in the L HARQ-ACK information bits having the same index among the N information blocks. For clarity, an example will be described with reference to FIG. 5C. FIG. 5C illustrates a schematic diagram 500C illustrating another example HARQ feedback for SPS transmission according to embodiments of the present disclosure. As shown in FIG. 5C, packet 504 may arrive at RAN in a point of time within a range of jitter 550. Occasions 550-553 are configured within a period, and the HARQ feedback is transmitted in a slot 554. The first device 110 does not know which one of the occasions 550-553 the packet 504 is transmitted on. In this example, N=4 and L=3. It is to be understood that this is merely an example, and N and L may be any other suitable values.

In the example of FIG. 5C, the first device 110 may perform blind detection on all the occasions 550-553 configured within a period, and generate respective HARQ-ACK information blocks B0, B1, B2 and B3 for the occasions 550, 551, 552 and 553. The information block B0 includes 3 HARQ-ACK information bits B00, B01 and B02 having indexes 0, 1 and 2. The information block B1 includes 3 HARQ-ACK information bits B10, B11 and B12 having indexes 0, 1 and 2. The information block B2 includes 3 HARQ-ACK information bits B20, B21 and B22 having indexes 0, 1 and 2. The information block B3 includes 3 HARQ-ACK information bits B30, B31 and B32 having indexes 0, 1 and 2.

Then, the first device 110 may perform OR operation on the HARQ-ACK information bits having the same index, respectively. For example, the first device 110 may perform OR operation on HARQ-ACK information bits B00, B10, B20 and B30 having the index 0 so as to obtain a HARQ-ACK information bit C0. The first device 110 may perform OR operation on HARQ-ACK information bits B01, B11, B21 and B31 having the index 1 so as to obtain a HARQ-ACK information bit C1. The first device 110 may perform OR operation on HARQ-ACK information bits B02, B12, B22 and B32 having the index 2 so as to obtain a HARQ-ACK information bit C2. In this way, the first device 110 may determine an information block C including the HARQ-ACK information bits C0, C1 and C2 and transmit the information block C in the slot 544.

In this way, the HARQ feedback for the one data transmission is transmitted from the first device 110 to the second device 120 with saved signaling overhead and in a simple way.

### Embodiment 3

In this embodiment, the second number is larger than one, i.e., M>1. This embodiment is beneficial for the larger data packet scenario, e.g., a high quality video stream frame (4K, 8K video), and multiple occasions may be needed.

A key characteristic of XR service is the varying packet size, the second device 120 may not exactly know how many occasions are needed in advance. Thus, the value of M may be the maximum number of occasions, and the second device 120 may estimate the value of M based on the maximum packet size and the channel quality. In some embodiments, the first device 110 may determine the positions of the M occasions based on explicit or implicit method and generate HARQ-ACK codebook only for the M occasions. In this way, transmission of packets with a large and varying packet size may be supported.

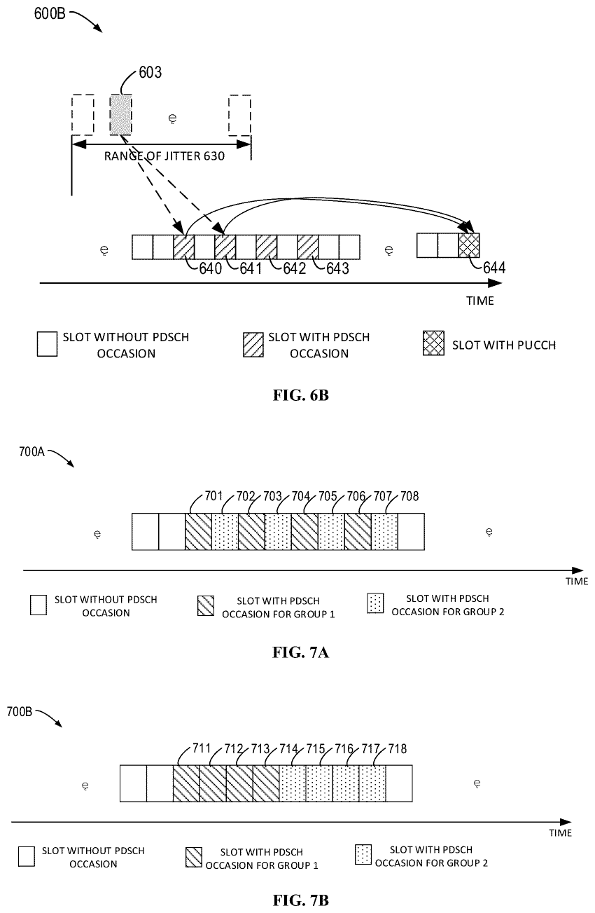

FIG. 6A illustrates a schematic diagram 600A illustrating an example SPS transmission according to embodiments of the present disclosure. As shown in FIG. 6A, packet 601 may arrive at RAN in a point of time within a range of jitter 610. Occasions 620-623 are configured within a first period, and occasions 624-627 are configured within a second period behind the first period. In this example, the second device 120 may transmit the packet 601 on the occasions 620 and 621. After packet arrival interval on average, packet 602 may arrive at RAN in a point of time within a range of jitter 620. The second device 120 may transmit the packet 602 on the occasions 626 and 627.

In some embodiments, if the at least one data transmission is received correctly on the M occasions in the N occasions, the first device 110 does not expect to correctly receive a data transmission on an occasion other than the M occasions in the N occasions. In this embodiment, if at least one data block is received correctly on an occasion, it is considered that a data transmission is received correctly on the occasion.

For example, if the first device 110 successfully detects M SPS PDSCHs in the N occasions and there are remaining occasions in the N occasions, the first device 110 may stop the detection of the remaining occasions.

FIG. 6B illustrates a schematic diagram 600B illustrating an example HARQ feedback for SPS transmission according to embodiments of the present disclosure. As shown in FIG. 6B, packet 603 may arrive at RAN in a point of time within a range of jitter 630. Occasions 640-643 are configured within a period. In this example, the second device 120 may transmit, to the first device 110, the packet 603 on the occasions 640 and 641, and the first device 110 may transmit a HARQ feedback for the occasions 640 and 641 in a slot 644.

For example, if the first device 110 successfully detects K SPS PDSCHs in the N occasions where K<M, there may be two possibilities. On one hand, the second device 120 may only transmit K SPS PDSCHs to the first device 110, and the first device 110 may detect all the K SPS PDSCHs. On the other hand, the second device 120 may transmit more than K SPS PDSCHs to the first device 110, and the first device 110 may miss-detect some of the more than K SPS PDSCHs.

Consequently, for the HARQ feedback, the first device 110 may generate HARQ-ACK information for all the N occasions in some embodiments. In this case, it is unnecessary for the first device 110 to distinguish which occasion it misses.

As another feasible solution, the first device 110 may generate HARQ-ACK information only for the M occasions. In this case, the first device 110 has to distinguish which occasion it misses. The latter solution is better than the former solution due to the low overhead. Some example embodiments will be described with reference to Examples 1-3 to provide solutions for indicating the position of the M occasions in the N occasions.

### Example 1

In this example, the N occasions are divided into several groups, and each group comprises M occasions. The second device 120 may only use one of the groups for data transmissions. The first device 110 does not expect to correctly receive two or more data transmissions belonging to different groups.

In some embodiments, if at least one data block for the at least one data transmission is received correctly on a fourth occasion in the N occasions, the first device 110 may determine the M occasions associated with the fourth occasion, and generate the M information blocks for the M occasions. For example, the first device 110 may determine a group that the fourth occasion belongs to and then determine the M occasions comprised in the group. In other words, the first device 110 may identify the actually used group if it successfully detects at least one data block in any of the N occasions, i.e., if the first device 110 detects a data block in a particular occasion, then the group which the particular occasion belongs to is determined as the actually used group.

In some embodiments, the groups may be configured as a distributed pattern. In this case, a group may comprise M non-consecutive occasions which are interlaced with occasions of another group. This will be further described with reference to FIG. 7A. FIG. 7A illustrates a schematic diagram 700A illustrating an example grouping of SPS configured occasions according to embodiments of the present disclosure. As shown in FIG. 7A, group 1 may comprise occasions 701, 703, 705 and 707, and group 2 may comprise occasions 702, 704, 706 and 708. Assuming that the first device 110 detects at least one data block in the occasion 703. Then the first device 110 may know that the group 1 is used by the second device 120 for data transmissions. In this case, the first device 110 may generate HARQ-ACK information for the group 1 and does not generate HARQ-ACK information for the group 2.

In some embodiments, the groups may be configured as a localized pattern. In this case, a group may comprise M consecutive occasions. This will be further described with reference to FIG. 7B. FIG. 7B illustrates a schematic diagram 700B illustrating an example grouping of SPS configured occasions according to embodiments of the present disclosure. As shown in FIG. 7B, group 1 may comprise occasions 711, 712, 713 and 714, and group 2 may comprise occasions 715, 716, 717 and 718. Assuming that the first device 110 detects at least one data block in the occasion 713. Then the first device 110 may know that the group 1 is used by the second device 120 for data transmissions. In this case, the first device 110 may generate HARQ-ACK information for the group 1 and does not generate HARQ-ACK information for the group 2.

In some embodiments, the groups may be configured as an arbitrary pattern indicated by a bit map. Of course, any other suitable ways are also feasible for the grouping.

### Example 2

In this example, the second device 120 may use M different sequences to indicate the positions and the order of the M occasions. In this case, the first device 110 may blind detect the sequences to identify an index of an occasion in the M occasions.

In some embodiments, the first device 110 may determine the M occasions from the N occasions based on a set of sequences associated with the M occasions, and generate the M information blocks for the M occasions. In some embodiments, the location of an information block for an occasion may depend on the order of the occasion in the M occasions.

In some embodiments, if no data transmission with a sequence is received correctly on the N occasions, the first device 110 may generate, for an occasion corresponding to the sequence, L HARQ-ACK information bits indicating NACKs as an information block corresponding to the occasion. In other words, if the first device 110 does not successfully detect a PDSCH with a particular sequence in the N occasions, the first device 110 may generate L NACK values for the occasion corresponding to the particular sequence.

In some embodiments, the sequence may be at least one of the following: a demodulation reference signal (DMRS), a wake-up signal, a synchronization signal, a phase-tracking reference signal (PTRS), channel state information-reference signal (CSI-RS) or the like. In some embodiments, the sequence may be embedded signaling in the data transmission. For example, the sequence may be a field of an embedded signaling similar as the configured grant-uplink control information (CG-UCI). It is to be understood that the sequence may adopt any other suitable types, and the present disclosure does not limit this aspect.

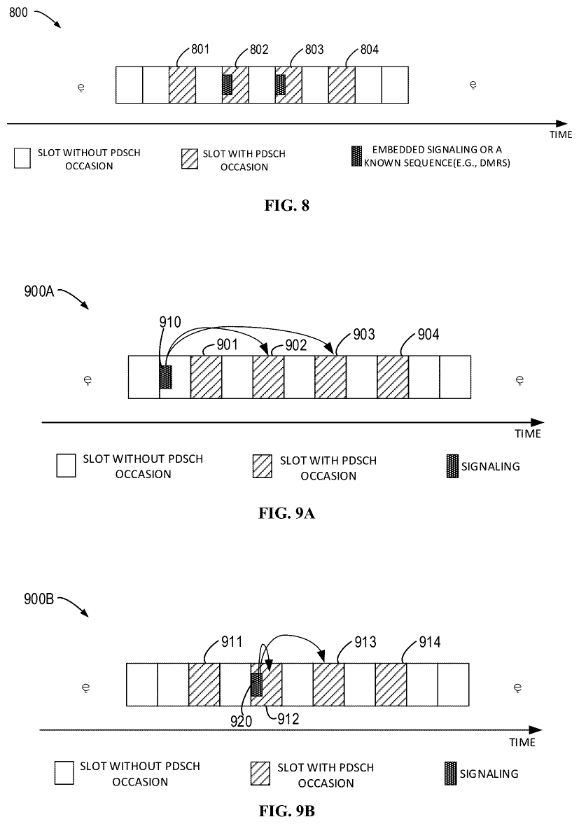

FIG. 8 illustrates a schematic diagram 800 illustrating an example indication of SPS configured occasions according to embodiments of the present disclosure. As shown in FIG. 8, there are 4 occasions 801, 802, 803 and 804. Assuming that L=1 and M=2, and the first device 110 successfully detects a data block in the occasions 802 and 803 with sequences 1 and 2 respectively. In this case, the first device 110 generates two ACKs for data transmissions with sequences 1 and 2 respectively.

Assuming that L=1 and M=3, and the first device 110 successfully detects a data block in the occasions 802 and 803 with sequences 2 and 3 respectively, but the first device 110 does not detect a data block in any of the occasions 801-804 with sequence 1. In this case, the first device 110 knows that a data transmission with sequence 1 is missed. Then the first device 110 may generate a NACK for the data transmission with sequence 1, and two ACKs for data transmissions with sequences 2 and 3 respectively.

### Example 3

In this example, the second device 120 may indicate the positions of the M occasions by a dynamic signaling. In some embodiments, the first device 110 may receive, from the second device 120, an indication indicating the M occasions, and generate M information blocks for the M occasions.

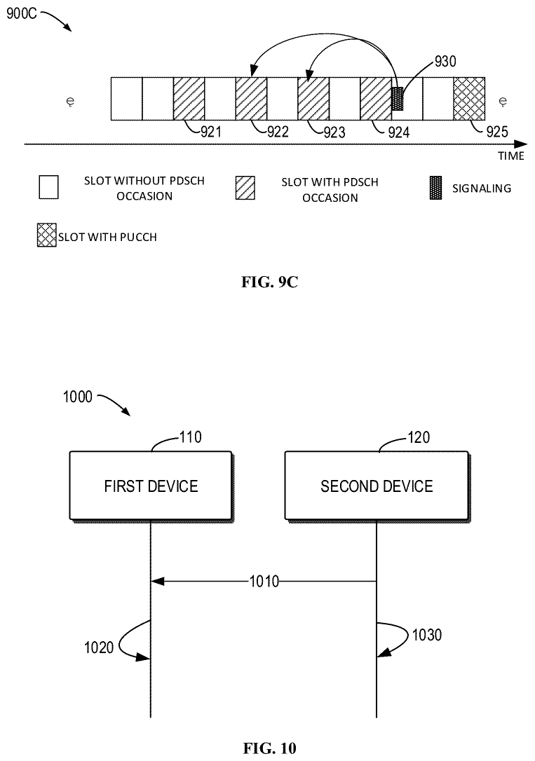

In some embodiments, the first device 110 may receive the indication in a slot (also referred to as a first slot herein) earlier than the first occasion in the N occasions. In other words, the second device 120 may transmit the indication before the first actually used occasion. FIG. 9A illustrates a schematic diagram 900A illustrating another example indication of SPS configured occasions according to embodiments of the present disclosure. As shown in FIG. 9A, there are occasions 901, 902, 903 and 904 configured within a period. The second device 120 may transmit a signaling or an indication 910 in a slot before the first occasion 901 among the occasions 901-904 to indicate that the occasions 902 and 903 are occasions to be actually used.

In some embodiments, the first device 110 may receive the indication on an occasion in the M occasions. In other words, the second device 120 may transmit the indication with any of one or more actually used occasions (i.e., it is unnecessary to be the first one). In some embodiments, the second device 120 may generate the indication by layer 1 (L1) signaling and multiplex the indication with a data transmission such as a PDSCH or an embedded signaling similar as CG-UCI. In some embodiments, the second device 120 may transmit the indication via a media access control (MAC) control element (CE). It is to be understood that the indication may also be transmitted in any other suitable ways.

FIG. 9B illustrates a schematic diagram 900B illustrating another example indication of SPS configured occasions according to embodiments of the present disclosure. As shown in FIG. 9B, there are occasions 911, 912, 913 and 914 configured within a period. The second device 120 may transmit a signaling or an indication 920 in a slot of the occasion 912 to indicate that the occasions 912 and 913 are the actually used occasions.

In some embodiments, the first device 110 may receive the indication in a slot (also referred to as a second slot herein) later than the last occasion in the M occasions and earlier than a slot (also referred to as a third slot herein) used for the transmission of the M information blocks. In some embodiments, the second device 120 may transmit the indication after at least one actually used occasion and before the HARQ feedback transmission which is associated with the actually used occasions. For example, the indication may be included in a HARQ-ACK request field, e.g., a one-slot HARQ-ACK request. In some embodiments, the indication may be a field of DL/UL scheduling DCI. In some embodiments, the indication may be a field of dedicated DCI.

FIG. 9C illustrates a schematic diagram 900C illustrating another example indication of SPS configured occasions according to embodiments of the present disclosure. As shown in FIG. 9C, there are occasions 921, 922, 923 and 924 configured within a period. The second device 120 may transmit a signaling or an indication 930 in a slot after the last occasion 924 among the occasions 921-924 and before slot 925 for HARQ feedback to indicate that the occasions 922 and 923 are the actually used occasions.

So far, solutions for HARQ feedback transmission are described for the case that multiple occasions are configured within a period and only part of the multiple occasions are actually used. With these solutions, the HARQ feedback overhead may be saved.

### Example Implementation of Determination of HARQ Process ID

Currently, for SPS/CG configuration, a HARQ process ID is determined based on a slot index and periodicity. For example, a HARQ process ID of a SPS occasion is determined by equation (1) below.

$$HARQ Process ID = [ floor ( CURRENT\_slot \times 10 / ( numberOfSlotsPerFrame \times periodicity ) ) ] modulo nrofHARQ - Processes \qquad ( 1 )$$

where CURRENT_slot=[(SFN×number OfSlotsPer Frame)+slot number in the frame] and numberOfSlotsPerFrame denotes the number of consecutive slots per frame.

The equation (1) is designed based on the fact that there is only one SPS/CG occasion in each SPS period. However, if multi-PDSCHs per SPS periodicity is supported, the equation (1) will cause collision among the occasions. Specifically, all the occasions within a same period will have the same HARQ process ID based on the above equation (1).

To support multi-PDSCHs per SPS periodicity, the above equation for HARQ process ID calculation should be enhanced by taking the number of occasions in each SPS period into account.

Embodiments of the present disclosure provide an improved solution for determining a HARQ process ID for each occasion in N occasions configured within a period. This will be described in details with reference to FIG. 10.

FIG. 10 illustrates a schematic diagram illustrating a process 1000 for communication according to embodiments of the present disclosure. For the purpose of discussion, the process 1000 will be described with reference to FIG. 1. The process 1000 may involve the first device 110 and the second device 120 as illustrated in FIG. 1.

As shown in FIG. 10, the second device 120 transmits 1010, to the first device 110, a configuration indicating a period and a first number of occasions within the period. The first number is denoted as N.

The first device 110 determines 1020 a HARQ process ID for an occasion in the N occasions at least based on a fourth number and an offset value for the occasion. In some embodiments, the fourth number may be N. In some embodiments, the fourth number may be a number less than N. For example, the fourth number may be the number of the actually used occasions (denoted as M). Similarly, the second device 120 determines 1030 a HARQ process ID for an occasion in the N occasions at least based on a fourth number and an offset value for the occasion.

In some embodiments, for an SPS configuration with multiple occasions per period, the HARQ process ID may be determined based on equation (2) below.

$$HARQ Process ID = [ floor ( CURRENT\_slot \times 10 / ( numberOfSlotsPerFrame \times periodicity ) ) * T + occasion\_offset ] modulo nrofHARQ - Processes \qquad ( 2 )$$

where T denotes the fourth number (the number of occasions in a single period or the number of actually used occasions in a single period, i.e., N or M), occasion_offset denotes an offset value of an occasion in the N or M occasions, CURRENT_slot=[(SFN×numberOfSlotsPerFrame)+slot number in the frame] and number OfSlotsPerFrame denotes the number of consecutive slots per frame.

In some embodiments where T denotes N, occasion_offset for an occasion may be determined based on a time domain order of the occasion in the N occasions. In some embodiments where T denotes M, occasion_offset for an occasion may be determined based on a time domain order of the occasion in the M occasions. For example, for the first occasion, occasion_offset may be 0, and for the second occasion, occasion_offset may be 1.

In general, the first device 110 may determine the occasions by SLIVs in activation DCI. However, some of the SLIVs may be invalid in a certain period, e.g., a PDSCH occasion indicated by a SLIV value may collide with at least one UL symbol.

In view of this, in some embodiments, the first device 110 may determine the offset value based on an order of a slot corresponding to the occasion among configured slots. In other words, occasion_offset may be determined based on the order of a SLIV in all the SLIVs.

In some alternative embodiments, the first device 110 may determine the offset value based on an order of a slot corresponding to the occasion among valid slots in the configured slots. In other words, occasion_offset may be determined only based on the order of a SLIV in the valid SLIVs. That is, an occasion with an invalid SLIV will not have a value of occasion_offset.

In this way, a HARQ process ID for multi-PDSCHs per SPS periodicity may be determined without collision and wasting of HARQ process IDs.

### Example Implementation of Methods

Accordingly, embodiments of the present disclosure provide methods of communication implemented at a terminal device and a network device. These methods will be described below with reference to FIGS. 11 to 14.

FIG. 11 illustrates an example method 1100 of communication implemented at a first device in accordance with some embodiments of the present disclosure. For example, the method 1100 may be performed at the first device 110 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

At block 1110, the first device 110 receives, from the second device 120, at least one data transmission on at least one occasion in a first number of occasions, the first number of occasions being configured within a period.

At block 1120, the first device 110 transmits, to the second device 120, a second number of information blocks for a HARQ feedback for the at least one data transmission, the second number being less than the first number.

In some embodiments where the second number is one, if at least one data block for the at least one data transmission is received correctly on a first occasion in the first number of occasions, the first device 110 does not expect to correctly receive a data block on a second occasion in the first number of occasions.

In some embodiments where the second number is one, if no data block for the at least one data transmission is received correctly on the first number of occasions, the first device 110 may generate, as the second number of information blocks, an information block comprising a third number of HARQ-ACK information bits indicating negative acknowledgements, the third number being equal to a configured number of data blocks for an occasion.

In some embodiments where the second number is one, if a first data block for the at least one data transmission is received correctly on a third occasion in the first number of occasions, the first device 110 may generate a HARQ-ACK information bit in the information block indicating a positive acknowledgement for the first data block in the information block. If a second data block for the at least one data transmission is received incorrectly on the third occasion, the first device 110 may generate a HARQ-ACK information bit in the information block indicating a negative acknowledgement for the second data block. In this way, an information block may be generated.

In some embodiments where the second number is one, the first device 110 may determine a position of the second number of information blocks in a HARQ-ACK codebook based on the first or last occasion in the first number of occasions, and place the second number of information blocks into the HARQ-ACK codebook based on the position.

In some embodiments where the second number is one and the at least one occasion comprises the first number of occasions, the first device 110 may generate the first number of information blocks for the first number of occasions, an information block in the first number of information blocks comprising third number of HARQ-ACK information bits, the third number of HARQ-ACK information bits indicating whether data blocks are received correctly on the respective occasion. Then the first device 110 may generate, as the second number of information blocks, an information block by performing OR operation on HARQ-ACK information bits having the same index in the third number of HARQ-ACK information bits among the first number of information blocks.

In some embodiments where the second number is one, the first device 110 may determine an identity of a HARQ process associated with the at least one data transmission based on an occasion in the first number of occasions.

In some embodiments where the second number is larger than one, if the at least one data transmission is received correctly on the second number of occasions in the first number of occasions, the first device 110 does not expect to correctly receive a data transmission on an occasion other than the second number of occasions in the first number of occasions.

In some embodiments where the second number is larger than one, if at least one data block for the at least one data transmission is received correctly on a fourth occasion in the first number of occasions, the first device 110 may determine the second number of occasions associated with the fourth occasion, and generate the second number of information blocks for the second number of occasions.

In some embodiments, the first number of occasions comprises multiple groups of occasions and the number of occasions included in one of the multiple groups is equal to the second number. In these embodiments, the first device 110 may determine the second number of occasions by determining one of the multiple groups that the fourth occasion belongs to.

In some embodiments where the second number is larger than one, the first device 110 may determine the second number of occasions from the first number of occasions based on a set of sequences associated with the second number of occasions, and generate the second number of information blocks for the second number of occasions.

In some embodiments where the second number is larger than one, if no data transmission with a sequence is received correctly on the first number of occasions, the first device 110 may generate, for an occasion corresponding to the sequence, third number of HARQ-ACK information bits indicating negative acknowledgements as an information block corresponding to the occasion.

In some embodiments where the second number is larger than one, the first device 110 may receive, from the second device 120, an indication indicating the second number of occasions, and generate the second number of information blocks for the second number of occasions. In some embodiments, the first device 110 may receive the indication in a first slot earlier than the first occasion in the second number of occasions. In some embodiments, the first device 110 may receive the indication on an occasion in the second number of occasions. In some embodiments, the first device 110 may receive the indication in a second slot later than the last occasion in the second number of occasions and earlier than a third slot used for the transmission of the second number of information blocks.

With the method of FIG. 11, an effect of jitter may be alleviated, complexity of a terminal device for blind detection may be reduced, and signaling overhead on HARQ feedback may be saved.

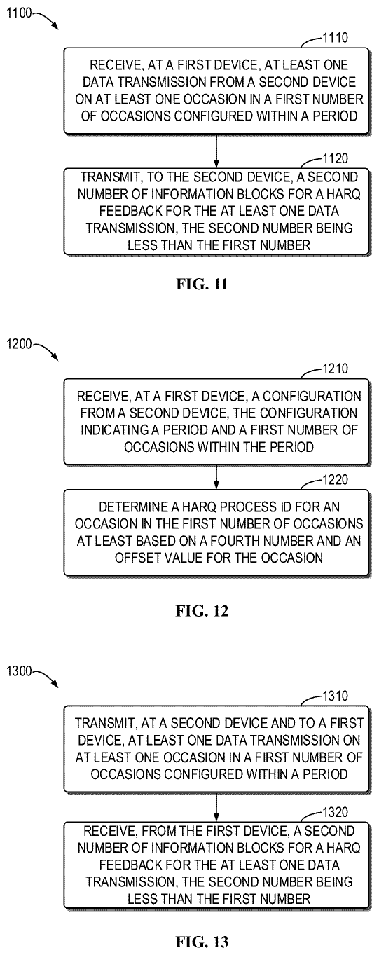

FIG. 12 illustrates another example method 1200 of communication implemented at a first device in accordance with some embodiments of the present disclosure. For example, the method 1200 may be performed at the first device 110 as shown in FIG. 1. For the purpose of discussion, in the following, the method 1200 will be described with reference to FIG. 1. It is to be understood that the method 1200 may include additional blocks not shown and/or may omit some blocks as shown, and the scope of the present disclosure is not limited in this regard.

At block 1210, the first device 110 receives, from the second device 120, a configuration indicating a period and a first number of occasions within the period.

At block 1220, the first device 110 determines an identity of a HARQ process for an occasion in the first number of occasions at least based on a fourth number and an offset value for the occasion. In some embodiments, the fourth number may be equal to the first number. In some embodiments, the fourth number may be less than the first number. For example, the fourth number may be the number of actually used occasions in the first number of occasions.

In some embodiments, the first device 110 may determine the offset value based on an order of a slot corresponding to the occasion among configured slots. In some embodiments, the first device 110 may determine the offset value based on an order of a slot corresponding to the occasion among valid slots in the configured slots.

With the method of FIG. 12, collision and waste in the HARQ process ID may be avoided.

FIG. 13 illustrates an example method 1300 of communication implemented at a second device in accordance with some embodiments of the present disclosure. For example, the method 1300 may be performed at the second device 120 as shown in FIG. 1. For the purpose of discussion, in the following, the method 1300 will be described with reference to FIG. 1. It is to be understood that the method 1300 may include additional blocks not shown and/or may omit some blocks as shown, and the scope of the present disclosure is not limited in this regard.

As shown in FIG. 13, at block 1310, the second device 120 transmits, to the first device 110, at least one data transmission on at least one occasion in a first number of occasions, the first number of occasions being configured within a period.

At block 1320, the second device 120 receives, from the first device 110, a second number of information blocks for a HARQ feedback for the at least one data transmission, the second number being less than the first number.

In some embodiments where the second number is one, the second device 120 may receive an information block comprising a third number of HARQ-ACK information bits indicating the HARQ feedback, the third number being equal to a configured number of data blocks for an occasion.

In some embodiments where the second number is one, the second device 120 may determine a position of the second number of information blocks in a HARQ-ACK codebook based on the first or last occasion in the first number of occasions, and obtain the second number of information blocks from the HARQ-ACK codebook based on the position.

In some embodiments where the second number is one, the second device 120 may determine an identity of a HARQ process associated with the at least one data transmission based on an occasion in the first number of occasions.

In some embodiments where the second number is larger than one, the first number of occasions may comprise multiple groups of occasions and the number of occasions included in one of the multiple groups may be equal to the second number. In these embodiments, the second device 120 may determine a group from the multiple groups, the group comprising the second number of occasions, and transmit the at least one data transmission on at least one occasion in the second number of occasions.

In some embodiments where the second number is larger than one, the second device 120 may determine the second number of occasions from the first number of occasions, the second number of occasions being associated with a set of sequences. Then, the second device 120 may transmit the at least one data transmission on at least one occasion in the second number of occasions.

In some embodiments where the second number is larger than one, the second device 120 may transmit, to the first device 110, an indication indicating the second number of occasions for the transmission of the at least one data transmission. In some embodiments, the second device 120 may transmit the indication in a first slot earlier than the first occasion in the second number of occasions. In some embodiments, the second device 120 may transmit the indication on an occasion in the second number of occasions. In some embodiments, the second device 120 may transmit the indication in a second slot later than the last occasion in the second number of occasions and earlier than a third slot used for the reception of the second number of information blocks.

With the method 1300, an effect of jitter may be alleviated, complexity of a terminal device for blind detection may be reduced, and signaling overhead on HARQ feedback may be saved.

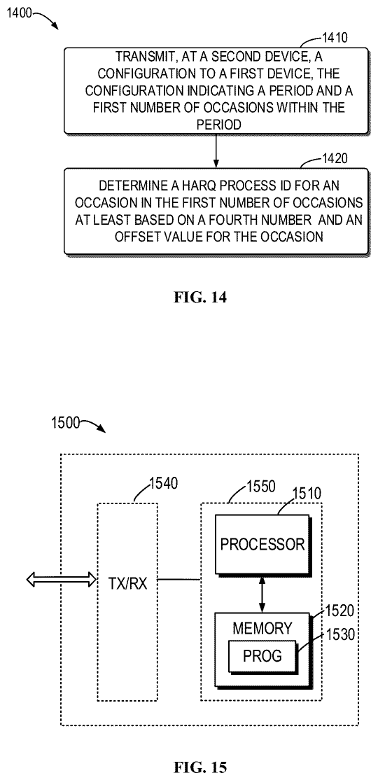

FIG. 14 illustrates another example method 1400 of communication implemented at a second device in accordance with some embodiments of the present disclosure. For example, the method 1400 may be performed at the second device 120 as shown in FIG. 1. For the purpose of discussion, in the following, the method 1400 will be described with reference to FIG. 1. It is to be understood that the method 1400 may include additional blocks not shown and/or may omit some blocks as shown, and the scope of the present disclosure is not limited in this regard.

As shown in FIG. 14, at block 1410, the second device 120 transmits, to the first device 110, a configuration indicating a period and a first number of occasions within the period.

At block 1420, the second device 120 determines an identity of a HARQ process for an occasion in the first number of occasions at least based on a fourth number and an offset value for the occasion. In some embodiments, the fourth number may be equal to the first number. In some embodiments, the fourth number may be less than the first number. For example, the fourth number may be the number of actually used occasions in the first number of occasions.

In some embodiments, the second device 120 may determine the offset value based on an order of a slot corresponding to the occasion among configured slots. In some embodiments, the second device 120 may determine the offset value based on an order of a slot corresponding to the occasion among valid slots in the configured slots.

With the method of FIG. 14, collision and waste in the HARQ process ID may be avoided.

### Example Implementation of Device

FIG. 15 is a simplified block diagram of a device 1500 that is suitable for implementing embodiments of the present disclosure. The device 1500 can be considered as a further example implementation of the first device 110 or the second device 120 as shown in FIG. 1. Accordingly, the device 1500 can be implemented at or as at least a part of the first device 110 or the second device 120.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1510 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1530 is assumed to include program instructions that, when executed by the associated processor 1510, enable the device 1500 to operate in accordance with the embodiments of the present disclosure, as discussed herein with reference to FIGS. 3 to 14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

In some embodiments, a first device comprises circuitry configured to: receive, from a second device, at least one data transmission on at least one occasion in a first number of occasions, the first number of occasions being configured within a period; transmit, to the second device, a second number of information blocks for a HARQ feedback for the at least one data transmission, the second number being less than the first number.

In some embodiments where the second number is one, the circuitry may be configured to receive the at least one data transmission by: in accordance with a determination that at least one data block for the at least one data transmission is received correctly on a first occasion in the first number of occasions, the first device does not expect to correctly receive a data block on a second occasion in the first number of occasions.

In some embodiments where the second number is one, the circuitry may be further configured to: in accordance with a determination that no data block for the at least one data transmission is received correctly on the first number of occasions, generate, as the second number of information blocks, an information block comprising a third number of HARQ-ACK information bits indicating negative acknowledgements, the third number being equal to a configured number of data blocks for an occasion.

In some embodiments where the second number is one, the circuitry may be further configured to generate, as the second number of information blocks, an information block by: in accordance with a determination that a first data block for the at least one data transmission is received correctly on a third occasion in the first number of occasions, generating a HARQ-ACK information bit in the information block indicating a positive acknowledgement for the first data block in the information block; and in accordance with a determination that a second data block for the at least one data transmission is received incorrectly on the third occasion, generating a HARQ-ACK information bit in the information block indicating a negative acknowledgement for the second data block.

In some embodiments where the second number is one, the circuitry may be further configured to determine a position of the second number of information blocks in a HARQ-ACK codebook based on the first or last occasion in the first number of occasions; and place the second number of information blocks into the HARQ-ACK codebook based on the position.

In some embodiments where the second number is one and the at least one occasion comprises the first number of occasions, the circuitry may be further configured to: generate the first number of information blocks for the first number of occasions, an information block in the first number of information blocks comprising third number of HARQ-ACK information bits, the third number of HARQ-ACK information bits indicating whether data blocks are received correctly on the respective occasion; and generate, as the second number of information blocks, an information block by performing OR operation on HARQ-ACK information bits having the same index in the third number of HARQ-ACK information bits among the first number of information blocks.

In some embodiments where the second number is one, the circuitry may be further configured to determine an identity of a HARQ process associated with the at least one data transmission based on an occasion in the first number of occasions.

In some embodiments where the second number is larger than one, if the at least one data transmission is received correctly on the second number of occasions in the first number of occasions, the first device does not expect to correctly receive a data transmission on an occasion other than the second number of occasions in the first number of occasions.

In some embodiments where the second number is larger than one, the circuitry may be further configured to: in accordance with a determination that at least one data block for the at least one data transmission is received correctly on a fourth occasion in the first number of occasions, determine the second number of occasions associated with the fourth occasion; and generate the second number of information blocks for the second number of occasions. In some embodiments where the first number of occasions comprises multiple groups of occasions and the number of occasions included in one of the multiple groups is equal to the second number, the circuitry may be configured to determine the second number of occasions by determining one of the multiple groups that the fourth occasion belongs to.

In some embodiments where the second number is larger than one, the circuitry may be further configured to: determine the second number of occasions from the first number of occasions based on a set of sequences associated with the second number of occasions; and generate the second number of information blocks for the second number of occasions. In some embodiments, the circuitry may be further configured to: in accordance with a determination that no data transmission with a sequence is received correctly on the first number of occasions, generate, for an occasion corresponding to the sequence, third number of HARQ-ACK information bits indicating negative acknowledgements as an information block corresponding to the occasion.

In some embodiments where the second number is larger than one, the circuitry may be further configured to: receive, from the second device, an indication indicating the second number of occasions; and generate the second number of information blocks for the second number of occasions. In some embodiments, the circuitry may be configured to receive the indication by at least one of the following: receiving the indication in a first slot earlier than the first occasion in the second number of occasions; receiving the indication on an occasion in the second number of occasions; or receiving the indication in a second slot later than the last occasion in the second number of occasions and earlier than a third slot used for the transmission of the second number of information blocks.

In some embodiments, a first device comprises a circuitry configured to: receive, from a second device, a configuration indicating a period and a first number of occasions within the period; and determine an identity of a HARQ process for an occasion in the first number of occasions at least based on a fourth number and an offset value for the occasion. In some embodiments, the fourth number may be equal to the first number. In some embodiments, the fourth number may be less than the first number.

In some embodiments, the circuitry may be configured to determine the identity of the HARQ process by one of the following: determining the offset value based on an order of a slot corresponding to the occasion among configured slots; and determining the offset value based on an order of a slot corresponding to the occasion among valid slots in the configured slots.

In some embodiments, a second device comprises a circuitry configured to: transmit, to a first device, at least one data transmission on at least one occasion in a first number of occasions, the first number of occasions being configured within a period; and receive, from the first device, a second number of information blocks for a HARQ feedback for the at least one data transmission, the second number being less than the first number.

In some embodiments where the second number is one, the circuitry may be configured to receive the second number of information blocks by: receiving an information block comprising a third number of HARQ-ACK information bits indicating the HARQ feedback, the third number being equal to a configured number of data blocks for an occasion.

In some embodiments where the second number is one, the circuitry may be configured to receive the second number of information blocks by: determining a position of the second number of information blocks in a HARQ-ACK codebook based on the first or last occasion in the first number of occasions; and obtaining the second number of information blocks from the HARQ-ACK codebook based on the position.

In some embodiments where the second number is one, the circuitry may be further configured to determine an identity of a HARQ process associated with the at least one data transmission based on an occasion in the first number of occasions.

In some embodiments where the second number is larger than one, the first number of occasions may comprise multiple groups of occasions and the number of occasions included in one of the multiple groups may be equal to the second number. In these embodiments, the circuitry may be configured to transmit the at least one data transmission by: determining a group from the multiple groups, the group comprising the second number of occasions; and transmitting the at least one data transmission on at least one occasion in the second number of occasions.

In some embodiments where the second number is larger than one, the circuitry may be configured to transmit the at least one data transmission by: determining the second number of occasions from the first number of occasions, the second number of occasions being associated with a set of sequences; and transmitting the at least one data transmission on at least one occasion in the second number of occasions.

In some embodiments where the second number is larger than one, the circuitry may be further configured to transmit, to the first device, an indication indicating the second number of occasions for the transmission of the at least one data transmission. In some embodiments, the circuitry may be configured to transmit the indication by at least one of the following: transmitting the indication in a first slot earlier than the first occasion in the second number of occasions; transmitting the indication on an occasion in the second number of occasions; or transmitting the indication in a second slot later than the last occasion in the second number of occasions and earlier than a third slot used for the reception of the second number of information blocks.

In some embodiments, a second device comprises a circuitry configured to: transmit, to a first device, a configuration indicating a period and a first number of occasions within the period; and determine an identity of a HARQ process for an occasion in the first number of occasions at least based on a fourth number and an offset value for the occasion. In some embodiments, the fourth number may be equal to the first number. In some embodiments, the fourth number may be less than the first number.

In some embodiments, the circuitry may be configured to determine the identity of the HARQ process by one of the following: determining the offset value based on an order of a slot corresponding to the occasion among configured slots; and determining the offset value based on an order of a slot corresponding to the occasion among valid slots in the configured slots.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-32. (canceled)

33. A method performed by a terminal device, the method comprising:
receiving, from a network, a configuration indicating a first period and a first number of at least one time duration for multiple data transmissions within the first period; and
determining, based on the first number of the at least one time duration for the multiple data transmissions and an offset value for each of the multiple data transmissions and the first period, an identity of a hybrid automatic repeat request (HARQ) process for each of the multiple data transmissions within the first period.

34. The method according to claim 33, wherein
the offset value for a first data transmission among the multiple data transmissions within the first period equals 0, and
the offset value for each of at least one data transmission after the first data transmission among the multiple data transmissions within the first period is determined based on the first number of the at least one time duration.

35. The method according to claim 33, wherein
the offset value is determined for a valid data transmission within the first period.

36. The method according to claim 33, wherein
the offset value for each of the at least one data transmission after the first data transmission among the multiple data transmissions within the first period is determined in ascending order based on the first number of the at least one time duration.

37. The method according to claim 33, wherein
the data transmission comprises a physical downlink shared channel (PDSCH), a physical uplink shared channel (PUSCH) or a physical sidelink shared channel (PSSCH).

38. The method according to claim 33, wherein
the time duration comprises slot, mini-slot, or symbol.

39. A terminal device comprising:
one or more memories storing instructions; and
one or more processors configured to process the instructions to control the terminal devices to:
receive, from a network, a configuration indicating a first period and a first number of at least one time duration for multiple data transmissions within the first period; and
determine, based on the first number of the at least one time duration for the multiple data transmissions and an offset value for each of the multiple data transmissions and the first period, an identity of a hybrid automatic repeat request (HARQ) process for each of the multiple data transmissions within the first period.

40. The terminal device according to claim 39, wherein
the offset value for a first data transmission among the multiple data transmissions within the first period equals 0, and
the offset value for each of at least one data transmission after the first data transmission among the multiple data transmissions within the first period is determined based on the first number of the at least one time duration.

41. The terminal device according to claim 39, wherein
the offset value is determined for a valid data transmission within the first period.

42. The terminal device according to claim 39, wherein
the offset value for each of the at least one data transmission after the first data transmission among the multiple data transmissions within the first period is determined in ascending order based on the first number of the at least one time duration.

43. The terminal device according to claim 39, wherein
the data transmission comprises a physical downlink shared channel (PDSCH), a physical uplink shared channel (PUSCH) or a physical sidelink shared channel (PSSCH).

44. The terminal device according to claim 39, wherein
the time duration comprises slot, mini-slot, or symbol.
